(19) United States
(12) Patent Application Publication
(10) Pub. No.: US 2018/0211199 A1
(43) Pub. Date: Jul. 26, 2018

(54) DECISION ENGINE FOR GENERATING INTERFACES TO SIMULATE AND OPTIMIZE EMPLOYEE SCHEDULING IN WORK LOCATIONS

(71) Applicant: CAPITAL ONE SERVICES, LLC, McLean, VA (US)

(72) Inventors: Michael BURY, Fairfax, VA (US); Tiravat ASSAVAPOKEE, Fairfax, VA (US); Changxing CHEN, Dunn Loring, VA (US)

(73) Assignee: CAPITAL ONE SERVICES, LLC, McLean, VA (US)

(21) Appl. No.: 15/924,794

(22) Filed: Mar. 19, 2018

Related U.S. Application Data
(63) Continuation of application No. 15/383,236, filed on Dec. 19, 2016.
(60) Provisional application No. 62/270,441, filed on Dec. 21, 2015.

(51) Int. Cl. G06Q 10/06

(52) U.S. Cl. CPC G06Q 10/063116; G06Q 10/067

(57) ABSTRACT

Systems and methods are disclosed for simulating and optimizing employee scheduling. In one embodiment, a decision engine includes a communication device, memory storing instructions, and a processor configured to execute the instructions to perform operations. The operations may include receiving service data including at least tasks of a first type, tasks of a second type, and a plurality of employee volumes, each indicating a number of first employees trained for the tasks of the first type, second employees trained for the tasks of the second type, and third employees trained for tasks of both types. The operations may further include generating, based on the service data a plurality of estimates, generating a simulation of some estimates, generating an optimized decision specifying an optimized number of first employees, second employees, and third employees, and causing at least one output device to display an interface associated with the optimized decision.

### CROSS-REFERENCE TO RELATED APPLICATION

This application claims priority to U.S. Provisional Patent Application Ser. No. 62/270,441 filed Dec. 21, 2015, the contents of which are hereby incorporated in their entirety.

### BACKGROUND

Customers visiting a work location may be served by employees of the work location. To improve customer service, it may be desirable to minimize the time between a customers arrival at the work location and the customer being served. This time is frequently referred to as the customers wait time.

To this end, employees at a work location may be staffed and scheduled to best serve customers by minimizing wait times. However, employees in a work location are typically trained to perform one or more tasks at the work location. Depending on the task requested by a customer, some employees may be trained to assist certain types of customers, while other employees may not be. Therefore, it may be desirable to consider tasks requested by customers in scheduling and staffing employees at the work location.

Decision engines may be used to determine scheduling and staffing of employees at work locations. However, typical decision engines are unable to account for the considerable variations among work locations, including variations in the tasks requested by customers, the skills of employees, and constraints of the work locations, such as physical limitations and/or hours of operation. Moreover, typical decision engines are unable to generate simulations that take into account these variations among work locations for use in determining scheduling and staffing of employees.

### SUMMARY

The disclosed embodiments include systems and methods for simulating and improving employee scheduling and staffing at one or more work locations.

In one embodiment, a decision engine is disclosed. The decision engine may include a communication device configured to communicate with at least one database and at least one output device. The decision engine may further include a memory storing instructions and a processor configured to execute the instructions to perform operations. The operations may include receiving service data for a work location from the at least one database. The service data may include at least a customer volume, tasks of a first type, tasks of a second type, and a plurality of employee volumes, each of which indicates a number of first employees trained for the tasks of the first type, a number of second employees trained for the tasks of the second type, and a number of third employees trained for tasks of both the first and second types. The operations may further include generating, based on the service data, a plurality of estimates, each of which corresponds to an employee volume and indicates an average wait time for each of the tasks. The operations may further include selecting, based on the average wait times, a subset of estimates from the plurality of estimates and receiving constraint data from the at least one database. The constraint data may include at least one of hours of operation for the work location, a number of queues at the work location, a maximum queue length at the work location, or physical features of the work location. The operations may further include generating, based on the constraint data, a simulation for each estimate in the subset of estimates and generating, based on the simulations, an optimized decision specifying an optimized number of first employees, an optimized number of second employees, and an optimized number of third employees. The operations may further include causing the at least one output device to display an interface associated with the optimized decision. While the term “optimized” is used throughout the disclosure, it will be understood that an “optimized” decision, number of employees, etc., may refer to any desirable, beneficial, improved, efficient, reasonably priced, and/or otherwise preferred decision.

In another embodiment, a method is disclosed. The method may include receiving service data for a work location from at least one database, where the service data includes at least a customer volume, tasks of a first type, tasks of a second type, or a plurality of employee volumes, each of which indicates a number of first employees trained for the tasks of the first type, a number of second employees trained for the tasks of the second type, and a number of third employees trained for tasks of both the first and second types. The method may further include generating, based on the service data, a plurality of estimates, each of which corresponds to an employee volume and indicates an average wait time for each of the tasks and selecting, based on the average wait times, a subset of estimates from the plurality of estimates. The method may further include receiving constraint data from the at least one database, where the constraint data includes at least one of hours of operation for the work location, a number of queues at the work location, a maximum queue length at the work location, or physical features of the work location. The method may further include generating, based on the constraint data, a simulation for each estimate in the subset of estimates and generating, based on the simulations, an optimized decision specifying an optimized number of first employees, an optimized number of second employees, and an optimized number of third employees. The method may further include causing at least one output device to display an interface associated with the optimized decision.

In yet another embodiment, a non-transitory computer-readable medium is disclosed. The computer-readable medium may store instructions that, when executed by a processor, cause the processor to perform operations. The operations may include receiving service data for a work location from at least one database, where the service data includes at least a customer volume, tasks of a first type, tasks of a second type, and a plurality of employee volumes, each of which indicates a number of first employees trained for the tasks of the first type, a number of second employees trained for the tasks of the second type, and a number of third employees trained for tasks of both the first and second types. The operations may further include generating, based on the service data, a plurality of estimates, each of which corresponds to an employee volume and indicates an average wait time for each of the tasks and selecting, based on the average wait times, a subset of estimates from the plurality of estimates. The operations may further include receiving constraint data from the at least one database, where the constraint data includes at least one of hours of operation for the work location, a number of queues at the work location, a maximum queue length at the work location, or physical features of the work location. The operations may further include generating, based on the constraint data simulation for each estimate in the subset of estimates and generating, based on the simulations, an optimized decision specifying an optimized number of first employees, an optimized number of second employees, and an optimized number of third employees. The operations may further include causing at least one output device to display an interface associated with the optimized decision.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an example system, consistent with disclosed embodiments;

FIG. 2 is a block diagram of an example decision engine, consistent with disclosed embodiments;

FIGS. 3A and 3B are block diagrams illustrating an example database and data, consistent with disclosed embodiments;

FIG. 4 is a flow chart illustrating an example decision engine process, consistent with disclosed embodiments; and

FIGS. 5A-5E illustrate an example bank branch decision engine process, consistent with disclosed embodiments.

### DETAILED DESCRIPTION

Reference will now be made in detail to the disclosed embodiments, examples of which are illustrated in the accompanying drawings

The disclosed systems and methods offer improved employee scheduling through the use of optimization, simulation, and generated interfaces. Unlike conventional decision engines, which are unable to account for considerable variations among work locations, including variations in the tasks requested by customers, the skills of employees, and constraints of the work locations, such as physical limitations and/or hours of operation, the disclosed systems and methods employ specific rules to generate estimates of customer wait times for various tasks at various work locations, taking into account such variations, and to select a subset of the generated estimates. Moreover, while typical decision engines are unable to generate simulations that take into account these variations among work locations, the disclosed systems and methods employ specific rules to generate simulations of each estimate in the subset of estimates. These simulations, based on which the disclosed systems and methods can generate interfaces for display to a user, provide an improved estimate of customer wait times for various tasks at various work locations. The disclosed systems and methods employ these generated simulations to select an optimized decision for employee scheduling. In these and other manner, the disclosed systems and methods employ specific rules to offer an improved decision engine for employee scheduling that offers greater flexibility, accuracy, and user interaction than conventional decision engines,

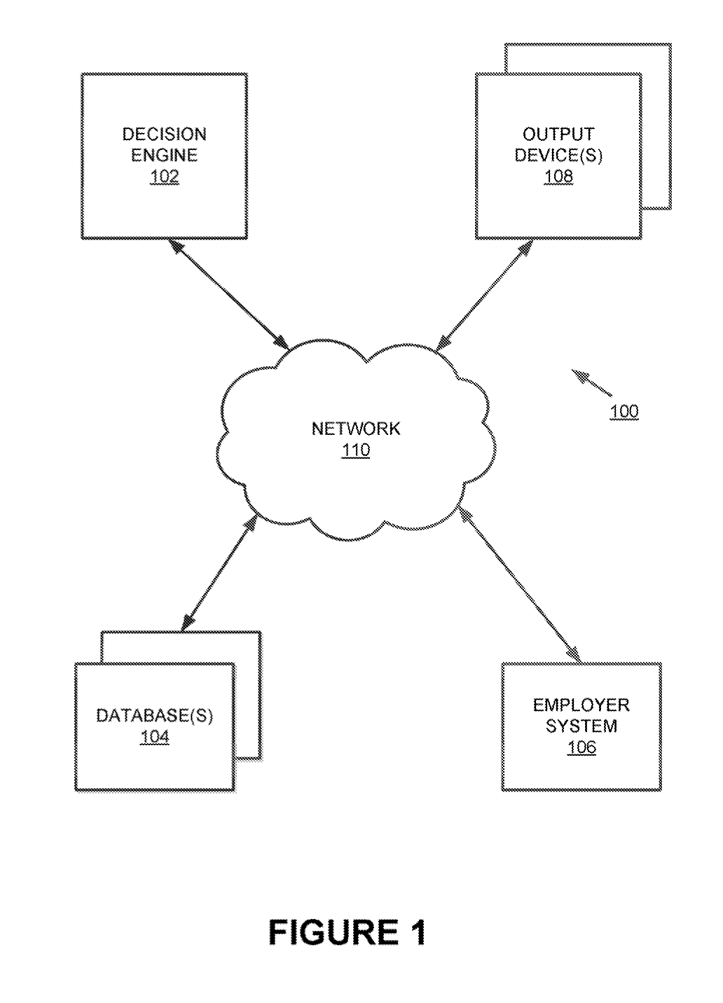

FIG. 1 is a block diagram of an example system 100, in accordance with disclosed embodiments. System 100 may be used to simulate and optimize employee scheduling in one or more work locations, in accordance with disclosed embodiments. System 100 may include a decision engine 102, database(s) 104, an employer system 106, and output device(s) 108, all of which may be communicatively coupled by a network 110.

While only one decision engine 102 and employer system 106 are shown, it will be understood that system 100 may include more or fewer than one of either of these components. Further, while multiple database(s) 104 and output device(s) 108 are shown, it will be understood that system 100 may include only one of either of these devices as well. The components and arrangements of the components included in system 100 may vary. Thus, system 100 may include other components that perform or assist in the performance of one or more processes consistent with disclosed embodiments.

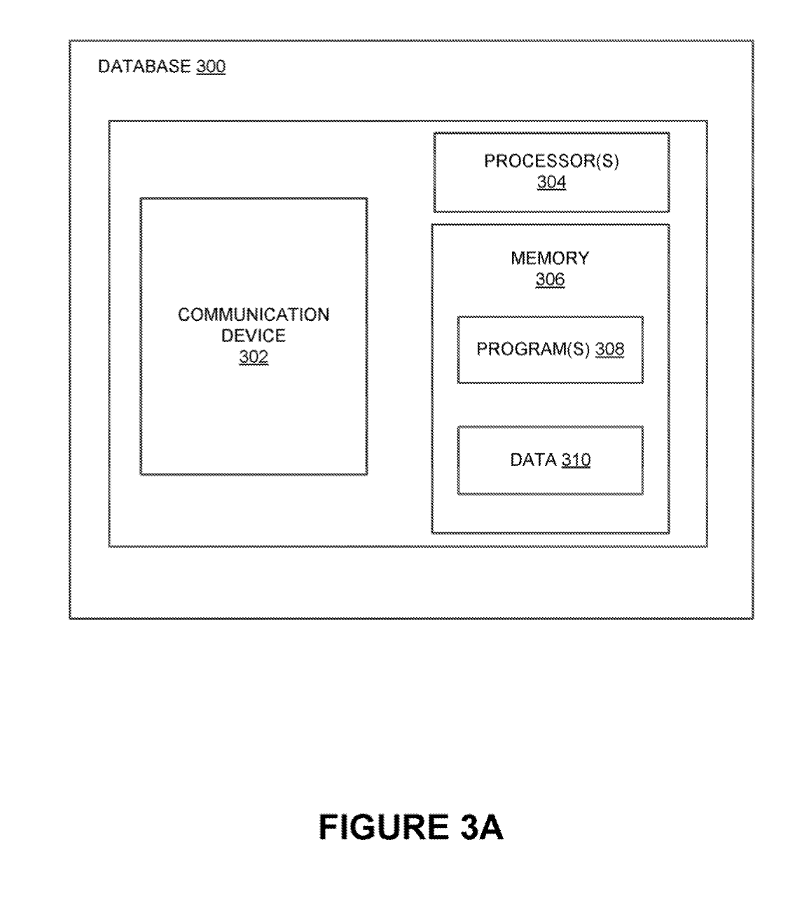

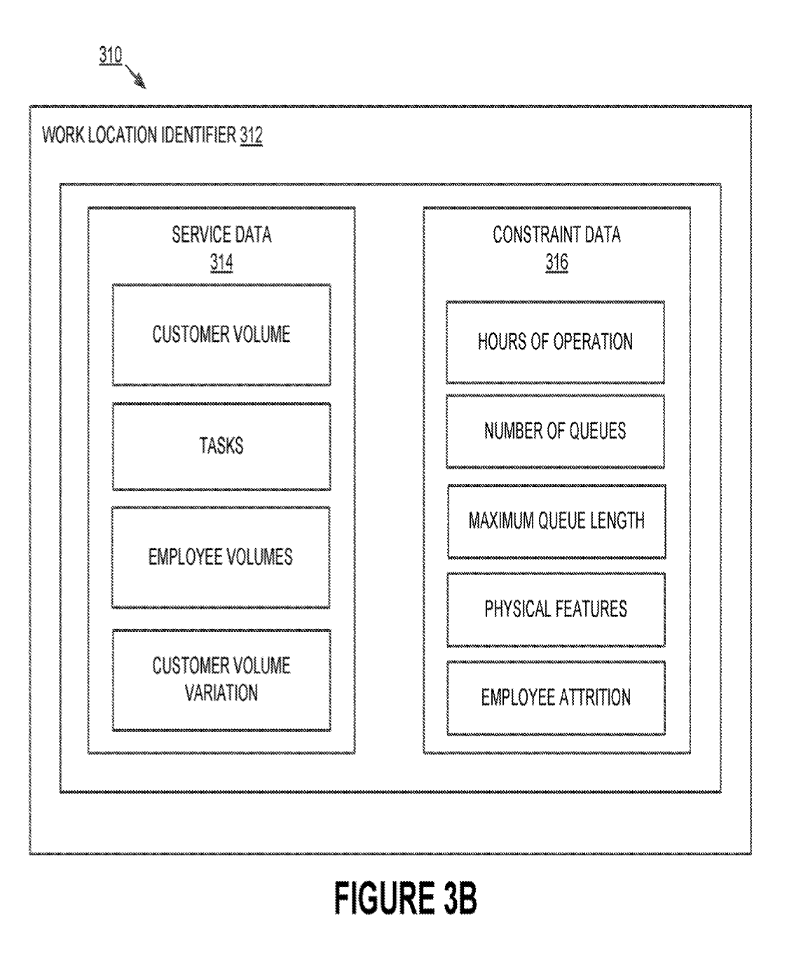

Decision engine 102 may include one or more computing systems configured to perform one or more operations consistent with simulating and optimizing employee scheduling in one or more work locations. In particular, decision engine 102 may be configured to receive service data and/or constraint data from database(s) 104. Further, decision engine 102 may be configured to generate a plurality of estimates based on the service data, select a subset of estimates, and generate simulations for each estimate in the subset of estimates. Still further, decision engine 102 may be configured to generate an optimized decision based on the simulations and cause output device(s) 108 to display an interface associated with the optimized decision. Decision engine 102 is further described below in connection with FIG. 3.

Database(s) 104 may be one or more computing devices configured to perform operations consistent with providing decision engine 102 with service data and/or constraint data for one or more work locations. Service data may include, for example, customer volume, tasks, a plurality of employee volumes, and/or customer volume variation for one or more work locations. Other types of service data may also be included. Constraint data may include, for example, hours of operation, a number of queues, a maximum queue length, physical features, and/or employee attrition for one or more work locations. Other types of constraint data may also be included,

While database(s) 104 are shown separately, in some embodiments database(s) 104 may be included in or otherwise related to decision engine 102.

Database(s) 104 may be configured to collect and/or maintain the service data and/or constraint data and provide it to decision engine 102. Database(s) 104 may collect the service data and/or constraint data from any number of sources, including, for instance, employer system 106, output device(s) 108, other employers systems (not shown), and/or third-party systems (not shown). Service data and/or constraint data may also be collected from other sources.

Employer system 106 may be one or more computing devices configured to perform operations consistent with providing decision engine 102 and/or database(s) 104 with service data and/or constraint data. While employer system 106 is shown separately, in some embodiments employer system 106 may be included in or otherwise related to one or both of database(s) 104 and decision engine 102.

Employer system 106 may be configured to collect and/or maintain service data and/or constraint data for one or more work locations and provide it to database(s) 104 and/or decision engine 102. For example, in some embodiments, employer system 106 may be associated with an employer and may collect and/or maintain service data and/or constraint data for one or more work locations operated by the employer.

Output device(s) 108 may be one or more computing devices configured to perform operations consistent with displaying interfaces associated with optimized decisions generated by decision engine 102. While output device(s) 108 are shown separately, in some embodiments output device(s) 108 may be included in or otherwise related to one or more of decision engine 102 database(s) 104, and employer system 106.

In some embodiments, output device(s) 108 may be further configured to perform operations consistent with providing decision engine 102 and/or database(s) 104 with service data and/or constraint data. Output device(s) 108 may be configured to collect and/or maintain service data and/or constraint data for one or more work locations and provide it to database(s) 104 and/or decision engine 102. For example, in some embodiments, output device(s) 108 may be associated with an employer and may collect and/or maintain service data and/or constraint data for one or more work locations operated by the employer. Output device(s) 108 may collect service data and/or constraint data through, for example, user input. Output device(s) 108 may collect service data and/or constraint data in other manners as well.

Network 110 may be any type of network configured to provide communications between components of system 100. For example, network 110 may be any type of connection (including infrastructure) that provides communications, exchanges information, and/or facilitates the exchange of information, such as the Internet, a Local Area Network, near field communication (NFC), optical code scanner or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

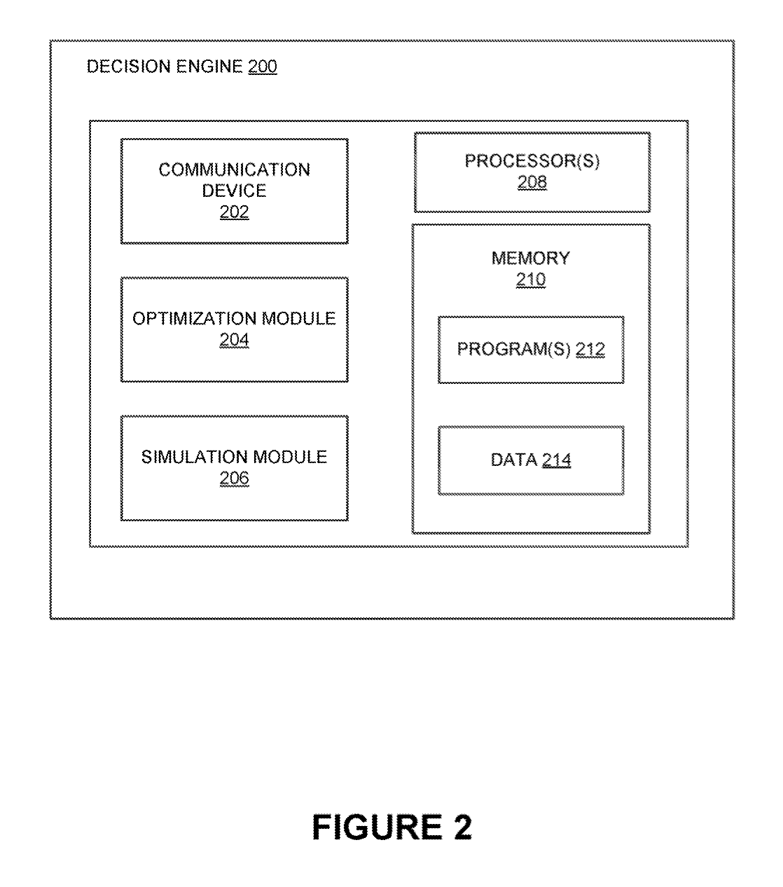

FIG. 2 is a block diagram of an example decision engine 200, in accordance with disclosed embodiments. As shown, decision engine 200 may include a communication device 202, an optimization module 204, a simulation module 206, one or more processor(s) 208, and memory 210 including one or more program(s) 212 and data 214.

In some embodiments, decision engine 200 may take the form of a server, general purpose computer, mainframe computer, or any combination of these components. Other implementations consistent with disclosed embodiments are possible as well.

Communication device 202 may be configured to communicate with one or more database(s), such as database(s) 104 described above, and one or more output devices, such as output device(s) 108 described above. In particular, communication device 202 may be configured to receive from the database(s) service data and/or constraint data for one or more work locations.

The service data may include, for example, customer volume, tasks, employee volumes,and/or customer volume variation for one or more work locations. The tasks may include tasks of a plurality of types. Tasks may include, for example, services sought by customers visiting the work location(s), such as customer transactions, inquiries, and/or services. Tasks may vary among work locations. For example, at a work location that is a retail store, tasks may include helping customers locate and/or select merchandise, assisting customers in testing merchandise, conducting purchase transactions with customers, and/or conducting return transactions with customers. As another example, at a work location that is a dental office, tasks may include assisting customers in making appointments, answering calls from customers, checking customers in upon arrival, conducting purchase transactions with customers, and/or performing dental work on customers. Other tasks are possible as well.

Employee volumes may indicate, for example, a number of first employees trained for tasks of the first type, a number of second employees trained for tasks of the second type, and a number of third employees trained for tasks of both the first and second types. The customer volume variation may be, for example, variation during hours of operation for the work location(s). Other service data are possible as well.

The constraint data may include, for example, hours of operation, a number of queues, a maximum queue length, physical features, and/or employee attrition for one or more work locations. Physical features of a work location may include, for example, whether the work location has a drive-through, the square footage or other layout features of a work location, and parking facilities of a work location. Other physical features are possible as well. Employee attrition may include, for example, employee vacation statistics, employee leave statistics, and employment termination statistics. Other employee attrition is possible as well. Other constraint data are possible as well.

Further, communication device 202 may be configured to cause the output device(s) to display one or more interfaces associated with simulations and/or optimized decisions generated by decision engine 200. To this end, communication device 202 may be configured to provide the interface(s) to the output device(s) and/or provide instructions for generating the interface(s) to the output device(s). Communication device 202 may cause the output device(s) to display the interface(s) n other manners as well.

Communication device 202 may be configured to communicate with other components as well, including, for example, one or more employer system(s), such as employer system 106 described above. Communication device 202 may include, for example, one or more digital and/or analog devices that allow communication device 202 to communicate with and/or detect other components, such as a network controller and/or wireless adaptor for communicating over the Internet. Other implementations consistent with disclosed embodiments are possible as well.

Optimization module 204 may be configured to generate estimates based on service data received by the decision engine 200. In some embodiments, each estimate may correspond to an employee volume received as service data and may indicate an average wait time for each of the tasks,

In some embodiments, the customer volume included in the service data may include customer arrival rates and/or average customer service times. For example, the service data may include a customer arrival rate and an average customer service time at one or more work locations and/or for one or more tasks. In some embodiments, optimization module 204 may be configured to generate an estimate corresponding to an employee volume and indicating an average wait time for the work location(s) and/or task(s) using the customer arrival rate, average customer service time, the employee volume for the estimate, and an estimation algorithm, such as, for instance, the Erlang-C formulas.

For example, according to the Erlang-C formulas, the probability that a customer has to wait, Ec, is given by:

$${E}_{c} ( m , u ) = \frac{\frac{{u}^{m}}{m !}}{\frac{{u}^{m}}{m !} + ( 1 - ρ ) {\sum }_{k = 0}^{m - 1} \frac{{u}^{k}}{k !}}$$

where m is an employee volume, u is a traffic intensity,, and p is an employee occupancy.

The employee volume, m, may be received by the decision engine 200 as service data. The traffic intensity, u, is given by.

u=λ·Tₛ

where λ is the customer arrival rate and is the average customer service time, both of which may be received by the decision engine 200 as service data..

The employee occupancy, p, is given by:

$$ρ = \frac{u}{m}$$

The average wait time, TW, is then given by

$${T}_{w} = \frac{{E}_{c} ( m , u ) \cdot {T}_{s}}{m \cdot ( 1 - ρ )}$$

where Tₛ is an average customer service time, which may be received by the decision engine 200 as service data. Thus, the Erlang-C formulas may be used by the optimization module 204 to determine average wait times for the plurality of employee volumes based on received service data.

The estimates may indicate other information determined by the optimization module 204 as well. In some embodiments, optimization module 204 may be configured to generate estimates using other formulas or algorithms as well, such as optimization using results from simulation module 206. The optimization module 204 may take other forms as well.

Optimization module 204 may be further configured to select a subset of estimates from the plurality of estimates generated by optimization module 204. In some embodiments, optimization module 204 may select the subset based on the average wait times indicated by the estimates.

In some embodiments, optimization module 204 may select the subset of estimates by selecting estimates having an average wait time for each of the tasks that is, for example, less than or within a predetermined range of a target wait time for each task. Alternatively or additionally, optimization module 204 may be configured to select the subset of estimates by selecting estimates having a probability, W(t), that a customer will be served for each task Within a target wait time, t, that is, for example, less than or within a predetermined range of a target probability that a customer will be served within a target time. The probability, W(t), may be determined, for example, according to an Erlang-C formula:

$$W ( t ) = 1 - {E}_{c} ( m , u ) \cdot {e}^{- ( m - u ) \frac{t}{{T}_{s}}}$$

Optimization module 204 may select the subset of estimates in other manners as well.

Simulation module 206 may be configured to generate, based on the constraint data received by communication device 202, a simulation for each estimate in the subset of estimates. Each simulation may, for example, simulate customer service at one or more work locations serviced by the employees indicated in the employee volume corresponding to the estimate. To this end, each simulation may reflect the service data used in generating the estimates, such as the customer volume, tasks, and the corresponding employee volume. Further, each simulation may reflect the constraint data received for the work location(s), such as the hours of operation, the number of queues, the maximum queue length, the physical features, and/or the employee attrition for the work location(s), in some embodiments, each simulation may simulate, for example, customer service for a customer arriving at a certain time and seeking a certain task from which the customer's wait time may be determined. The simulations may take other forms as well.

In some embodiments, simulation module 206 may be further configured to generate one or more interfaces associated with the simulations. In some embodiments, the interface(s) may graphically illustrate the simulations. For example, the interface(s) may graphically illustrate the work location As another example, the interface(s) may graphically simulate customer volumes and/or average wait times. The interface(s) may take other forms as well.

In some embodiments, simulation module 206 may generate the simulations according to, for example, customer inter-arrival distributions, which may be distributed according to, for instance, exponential distribution or according to other parameters, and service time distributions, which may be distributed according to, for instance, uniform distribution, gamma distribution, Weibull distribution, normal distribution, log-normal distribution, beta distribution, and/or triangular distribution. Other distributions for the customer inter-arrival and/or service times are possible as well. Simulation module 206 may take other forms as well.

Returning to optimization module 204, optimization module 204 may be further configured to generate an optimized decision based on the simulations generated by the simulation module 206. The optimized decision may specify an optimized number of first employees, an optimized number of second employees, and an optimized number of third employees. The optimized numbers may be any number, including zero. In some embodiments, the optimized decision may additionally specify an optimized work schedule for each employee in the optimized number of first employees, the optimized number of second employees, and the optimized number of third employees.

In some embodiments, optimization module 204 may determine the optimized decision by comparing, for example, various numbers and work schedules of first, second, and third employees in connection with the simulations in order to determine an optimized number and/or optimized work schedule of first, second, and third employees. For example, optimization module 204 may consider whether and/or when a first employee or a third employee should be scheduled to perform tasks of the first type. As another example, optimization module 204 may consider whether and/or when a second employee or a third employee should be scheduled to perform tasks of the second type. Other examples as possible as well. Optimization module 204 may consider, for example, relative cost of the first, second, and/or third employees and/or relative efficiency of the first, second, and/or third employees. Other considerations are possible as well.

Optimization module 204 may be further configured to generate one or more interfaces associated with the optimized decision. In some embodiments, the interface(s) may graphically illustrate the optimized decision. For example, the interface(s) may graphically indicate the optimized number(s) of first, second, and/or third employees. As another example, the interface(s) may graphically illustrate an optimized work schedule for the optimized number(s) of first, second, and/or third employees. The interface(s) may take other forms as well.

Processor(s) 208 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. The disclosed embodiments are not limited to any type of processor(s) otherwise configured to meet the computing demands of different components of decision engine 200.

Memory 210 may include one or more storage devices configured to store instructions used by processor(s) 208 to perform functions related to disclosed embodiments. For example, memory 210 may be configured with one or more software instructions, such as program(s) 212, that may perform one or more operations when executed by processor(s) 208. The disclosed embodiments are not limited to separate programs or computers configured to perform dedicated tasks. For example, memory 210 may include a single program 212 that performs the functions of decision engine 200, or program(s) 212 may comprise multiple programs. Memory 210 may also store data 214 that is used by program(s) 212.

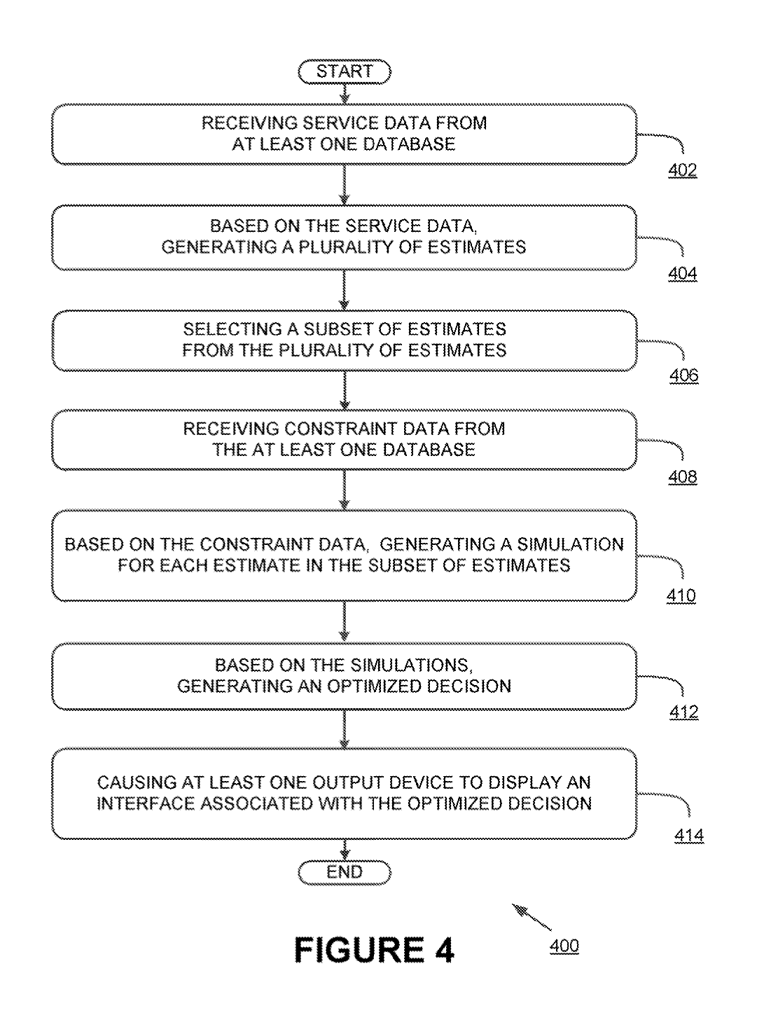

In certain embodiments, memory 210 may store sets of instructions for carrying out the processes described below in connection with FIG. 4. Other instructions are possible as well. In general, instructions may be executed by processor(s) 208 to perform one or more processes consistent with disclosed embodiments.

The components of decision engine 200 may be implemented in hardware, software, or a combination of both hardware and software, as will be apparent to those skilled in the art. For example, although one or more components of decision engine 200 may be implemented as computer processing instructions, all or a portion of the functionality of decision engine 200 may be implemented instead in dedicated electronics hardware.

FIGS. 3A and 3B are block diagrams illustrating an example database 300 and data 310, consistent with disclosed embodiments. As shown in FIG. 3A, database 300 may include a communication device 302, one or more processor(s) 304, and memory 306 including one or more program(s) 308 and data 310.

In some embodiments, database 300 may take the form of a server, general purpose computer, mainframe computer, or any combination of these components. Other implementations consistent with disclosed embodiments are possible as well.

Communication device 302 may be configured to communicate with one or more decision engine(s), such as decision engines 102 and 200 described above. In particular, communication device 302 may be configured to provide to the decision engine(s) service data and/or constraint data for one or more work locations. Communication device 302 may be configured to communicate with other components as well, including, for example, one or more employer system(s), such as employer system 106 described above, and one or more output device(s), such as output device(s) 108 described above. Communication device 302 may take any of the forms described above for communication device 202.

Processor(s) 304, memory 306, program(s) 308, and data 310 may take any of the forms described above for processor(s) 208, memory 210, program(s) 212, and data 214, respectively. The components of database 300 may be implemented in hardware, software, or a combination of both hardware and software, as will be apparent to those skilled in the art. For example, although one or more components f database 300 may be implemented as computer processing instructions, all or a portion of the functionality of database 300 may be implemented instead in dedicated electronics hardware.

Data 310 may include, for example, service data and/or constraint data for one or more work locations. FIG. 3B is a block diagram illustrating example data 310 stored at the database 30a As shown, the data 310 includes a work location identifier 312. Work location identifier 312 may be, for example, an alphanumeric or other identifier that identifies a work location. Data 312 may further include service data 314 and constraint data 316 for the work location identified by work location identifier 312.

Service data 314 may include, for example, customer volume, tasks, employee volumes, and/or customer volume variation for the work location identified by work location identifier 312. Tasks may include, for example, at least tasks of a first type and tasks of a second type. The customer volume may include, for example, a customer volume for tasks of the first type and a customer volume for tasks of the second type. Each employee volume may indicate, for example, a number of first employees trained for tasks of the first type, a number of second employees trained for tasks of the second type, and a number of third employees trained for tasks of both the first and second types. The customer volume variation may be, for example, variation during hours of operation for the work location. Other service data 314 are possible as well.

Constraint data 316 may include, for example, hours of operation, a number of queues, a maximum queue length, physical features, and/or employee attrition for the work location identified by work location identifier 312. Physical features of the work location may include, for example, whether the work location has a drive-through, the square footage or other layout features of a work location, and parking facilities of a work location. Employee attrition may include, for example, employee vacation statistics,, employee leave statistics, and employment termination statistics. Other constraint data 316 are possible as well.

While data 310 is shown to have a particular organization or structure, it will be understood that this organization or structure is merely illustrative. Other organizations and structures of data 310 are possible as well. For example, in some embodiments, service data 314 and/or constraint data 316 may be stored separately, in another database or elsewhere in the same database 300 As another example, in some embodiments, service data 314 and/or constraint data 316 for more than one work location may be stored together. Other examples are possible as well.

FIG. 4 is an example flow chart illustrating a decision engine process 400, in accordance with disclosed embodiments. Decision engine process 400 may be carried out, for example, by a decision engine, such as decision engines 102 and 200 described above.

As shown, decision engine process 400 begins at step 402 with receiving service data from at least one database. In some embodiments, the decision engine may include a communication device, such as communication devices 202 and/or 302 described above, that is configured to receive the service data from the at least one database. The service data may be, for example, service data for a work location. The database may be similar to, for example, database(s) 104 and/or database 300 described above.

The service data may include, for example, a customer volume, tasks, and a plurality of employee volumes. The tasks may include, for example, tasks of a first type and tasks of a second type. The customer volume may include, for example, a customer volume for tasks of the first type and a customer volume for tasks of the second type. Each employee volume in the plurality of employee volumes may indicate, for example, a number of first employees trained for tasks of the first type, a number of second employees trained for tasks of the second type, and a number of third employees trained for tasks of both the first and second types. Other service data are possible as well.

Decision engine process 400 continues at step 404 where, based on the service data, the decision engine may generate a plurality of estimates based on the service data. In some embodiments, the decision engine may include an optimization module, such as optimization module 204 described above, that is configured to generate the estimates based on the service data. Each estimate may correspond to an employee volume in the plurality of employee volumes. Further, each estimate may indicate an average wait time for each of the tasks. For example, each estimate may indicate an average wait time for tasks of the first type and an average wait time for tasks of the second type.

As noted above, in some embodiments the customer volume received as service data in step 402 may include, for example, a customer volume for tasks of the first type and a customer volume for tasks of the second type. In some embodiments, the decision engine may generate the estimate corresponding to an employee volume by determining the average wait time for tasks of the first type based on the customer volume for tasks of the first type and the number of first employees and the number of third employees indicated by the employee volume. Similarly, the decision engine may determine the average wait time for tasks of the second type based on the customer volume for tasks of the second type and the number of second employees and the number of third employees indicated by the employee volume.

At step 406, the decision engine may select a subset of estimates from the plurality of estimates generated in step 404. In some embodiments, the decision engine may include an optimization module, such as optimization module 204 described above, configured to select the subset of estimates.

In some embodiments, the decision engine may select the subset of estimates based on the average wait times indicated by the estimates in the plurality of estimates. For example, in some embodiments, the decision engine may select for the subset estimates having an average wait time less than and/or within a predetermined range of a target wait time. The decision engine may select the subset of estimates in other manners as well.

At step 408, the decision engine may receive constraint data from the at least one database. The decision engine may receive the constraint data from the same database as the service data, or from another database. Alternatively or additionally, in some embodiments, the decision engine may receive some or all of the constraint data from at least one output device, such as output device(s) 108 described above.

The constraint data may include, for example, at least one of hours of operation for the work location, a number of queues at the work location, a maximum queue length at the work location, and physical features of the work location. Physical features of the work location may include, for example, whether the work location has a drive-through, the square footage or other layout features of the work location, and parking of the work location. Other physical features are possible as well. In some embodiments, the constraint data may further include employee attrition at the work location. Employee attrition may include, for example, employee vacation statistics, employee leave statistics, and employment termination statistics. Other constraint data are possible as well.

Decision engine process 400 continues at step 410 where, based on the constraint data, the decision engine may generate a simulation for each estimate in the subset of estimates. In some embodiments, the decision engine may include a simulation module, such as simulation module 206 described above, configured to generate the simulations.

Each simulation may, for example, simulate customer service at one or more work locations serviced by the employees indicated in the employee volume corresponding to the estimate. To this end, each simulation may reflect the service data used in generating the estimates, such as the customer volume, tasks, and the corresponding employee volume. Further, each simulation may reflect the constraint data received for the work location, such as the hours of operation, the number of queues, the maximum queue length, the physical features, and/or the employee attrition for the work location. In some embodiments, each simulation may simulate, for example, customer service for a customer arriving at a certain time and seeking a certain task from which the customer's wait time may be determined. The simulations may take other forms as well.

Decision engine process 400 continues at step 412 where, based on the simulations, the decision engine may generate an optimized decision. In some embodiments, the decision engine may include an optimization module, such as optimization module 204 described above, configured to generate the optimized decision.

The optimized decision may specify, for example, an optimized number of first employees, an optimized number of second employees, and an optimized number of third employees. The optimized numbers may be any number, including zero. Alternatively or additionally, in some embodiments, the optimized decision may further specify an optimized work schedule for each employee in the optimized number of first employees, the optimized number of second employees, and the optimized number of third employees.

In some embodiments, the decision engine may determine the optimized decision by comparing, for example, various numbers and work schedules of first, second, and third employees in connection with the simulations in order to determine an optimized number and/or optimized work schedule of first, second, and third employees. For example, the decision engine may consider whether and/or when a first employee or a third employee should be scheduled to perform tasks of the first type. As another example, the decision engine may consider whether and/or when a second employee or a third employee should be scheduled to perform tasks of the second type. Other examples as possible as well. The decision engine may consider, for example, relative cost of the first, second, and/or third employees and/or relative efficiency of the first, second, and/or third employees. Other considerations are possible as well.

At step 414, the decision engine may cause at least one output device to display an interface associated with the optimized decision. More than one interface is possible as well. In some embodiments, the interface(s) may graphically illustrate the optimized decision. For example, the interface(s) may graphically indicate the optimized number(s) of first, second, and/or third employees. As another example, the interface(s) may graphically illustrate an optimized work schedule for the optimized number(s) of first, second, and/or third employees. The interface(s) may take other forms as well.

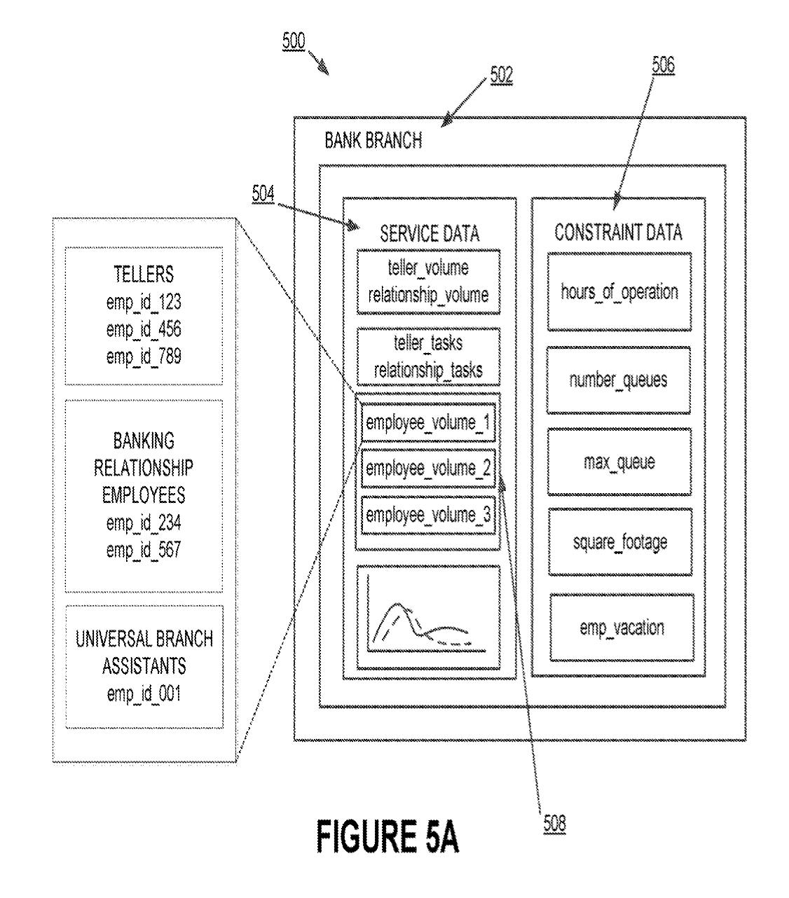

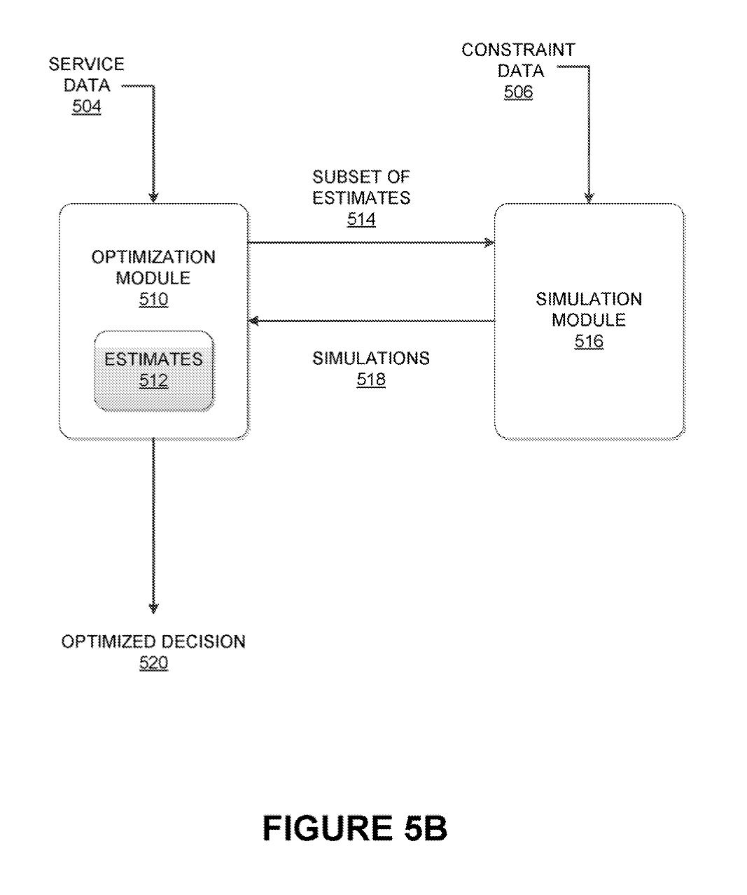

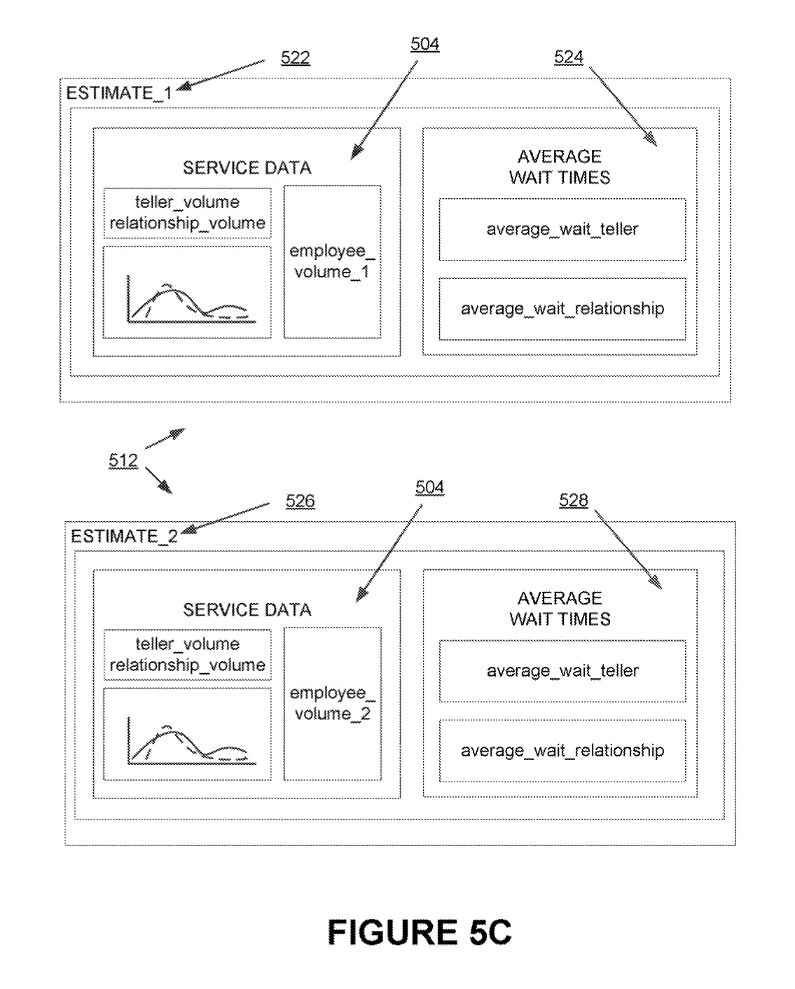

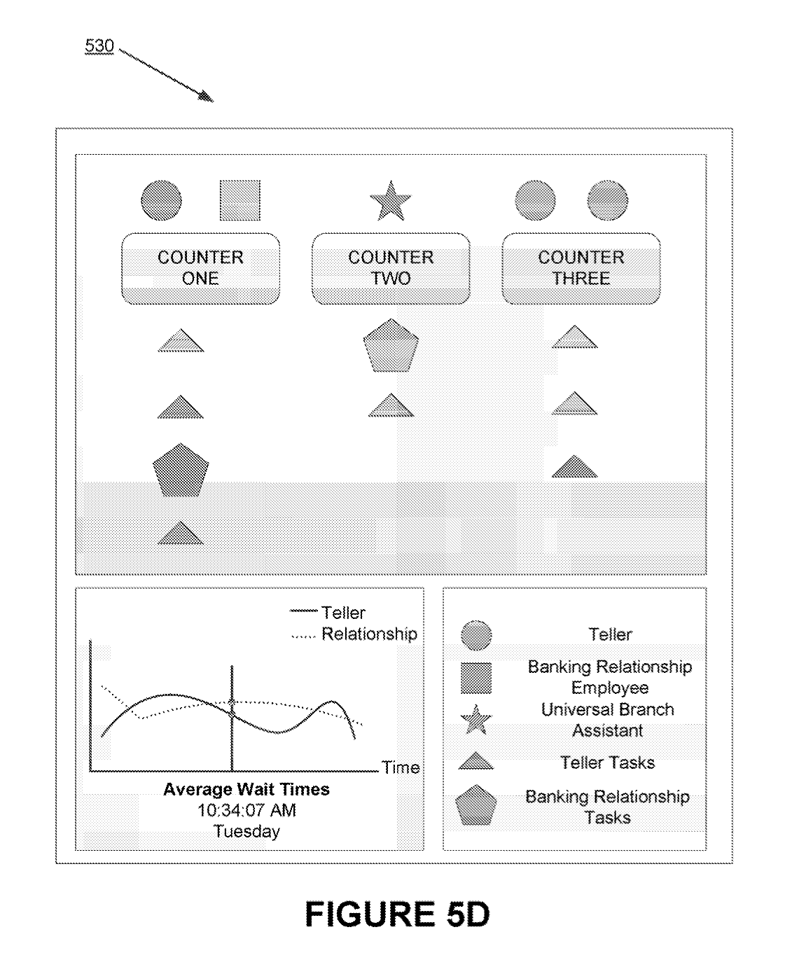

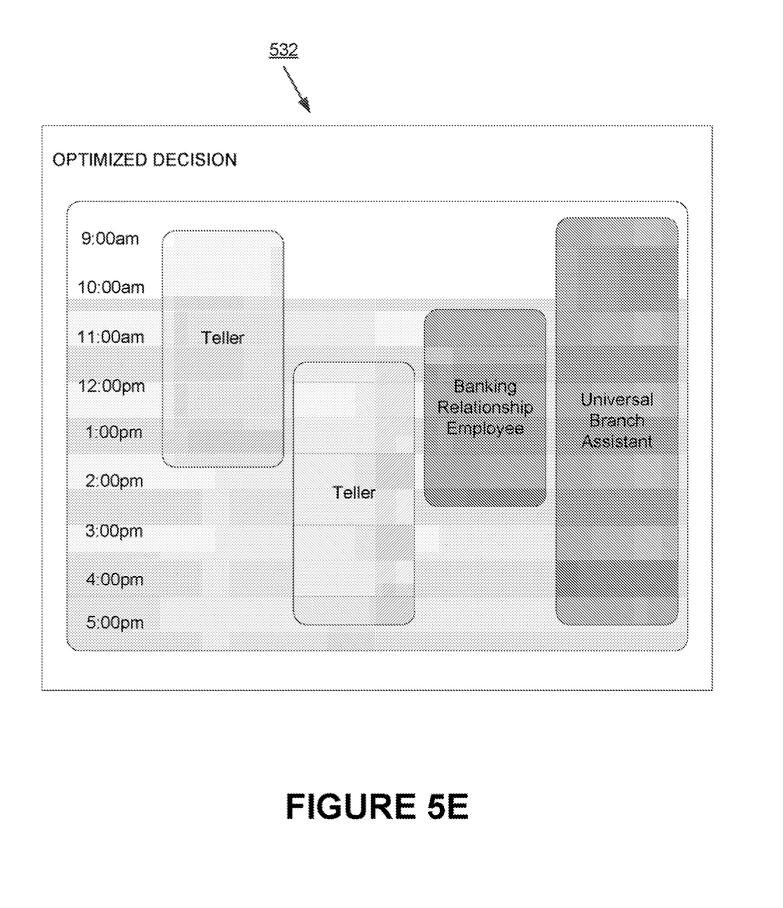

FIGS. 5A-5E illustrate an example bank branch decision engine process, in accordance with disclosed embodiments. An employer, such a bank, may operate one or more work locations, such as bank branches. The employer may employ a number of employees to work at each bank branch. Different types of employees may be employed. For example, the employees may include first employees trained for tasks of a first type, such as tellers trained for teller tasks. The employees may further include second employees trained for tasks of a second type, such as banking relationship employees trained for banking relationship tasks. The employees may further include third employees trained for tasks of both the first and second type, such as universal branch assistants trained for both teller tasks and banking relationship tasks. The disclosed methods any systems may be used to simulate and optimize scheduling of the employees at the bank branch.

As shown in FIG. 5A, a database may maintain data 500 for a work location, such as a bank branch 502. Bank branch 502 may, for example, be one of any number of bank branches operated by the bank. The database may maintain similar data for the other bank branches as well.

Data 500 may be collected and/or maintained by the bank and/or one or more third parties. For example, data 500 may be input by employees of the bank. As another example, data 500 may be collected by a data service. Other examples are possible as well. As shown, data 500 for bank branch 502 may include service data 504 and constraint data 506.

Service data 504 may indicate, for example, customer volume at bank branch 502. As shown, the customer volume may indicate both a customer volume for teller tasks (“teller_volume”) at bank branch 502 and a customer volume for banking relationship tasks (“relationship_volume”) at bank branch 502.

Service data 504 may further indicate, for example, tasks at bank branch 502. As shown, the tasks include teller tasks (“teller_tasks”) and banking relationship tasks (“relationship_tasks”).

Service data 504 may further indicate, for example, a plurality of employee volumes 503 (“employee_volume_1”, “employee_volume_2,” “employee_volume_3”). Each employee volume may indicate a number of tellers, banking relationship employees, and universal branch assistants. For example, as shown in the expanded box, “employee_volume_1” may indicate a number of tellers (“emp_id_123”, (“emp_id_436,” “emp_id_789”), a number of banking relationship employees (“emp_id_234”, “emp_id_567”), and a number of universal branch assistants (“emp_id_001”). In some embodiments, the number of tellers, banking relationship employees, and/or universal branch assistants may specify both a number of employees and identify individual employees (e.g., using employee identifiers). Alternatively or additionally, the number of tellers, banking relationship employees, and/or universal branch assistants may simply specify a number of employees, without identifying individual employees.

Service data 504 may further indicate a customer volume variation shown as a graph). The customer volume variation may indicate a variation in customer volume during the hours of operation for bank branch 502. In some embodiments, the customer volume variation may indicate a variation in customer volume for teller tasks, as well as a variation in customer volume for relationship banking tasks.

Constraint data 506 may indicate, for example, hours of operation (“hours_of_operation”) for bank branch 502, a number of queues (“number_queues”) at bank branch 502, a maximum queue length (“max_queue”) for one or more queues at bank branch 502, one or ore physical features (e.g., “square_footage”) of the bank branch 502, and/or employee attrition (e.g., “emp_vacation”) at bank branch 502.

The hours of operation may indicate, for instance, hours during which bank branch 502 is open to customers. For example, the hours of operation may indicate hours for each day of the week and/or holiday.

The number of queues may indicate, for instance, a number of queues that may be formed at bank branch 502. For example, if bank branch 502 is equipped with three points-of-service (e.g., counters) at which customers can be served, the number of queues that can be formed may be three.

The maximum queue length may indicate, for instance, a maximum number of customers that may stand in a queue,given the physical layout of bank branch 502. For example, if bank branch 502 is small in size, the maximum queue length may be small. The maximum queue length may specify a maximum queue length for each queue in the number of queues, or may specify a single maximum for all queues.

The physical features may indicate physical features of bank branch 502. For example, the physical features of bank branch 502 may include whether bank branch 502 has a drive-through, the square footage, furniture layout, or other layout features of bank branch 502, and parking facilities available at bank branch 502.

The employee attrition may indicate, for example, employee vacation statistics, employee leave statistics, and employment termination statistics, or any other information indicating a temporary or permanent employee absence.

While certain data 500 for bank branch 502 are shown, it will be understood that other data, including other types of data, are possible as well.

As shown in FIG. 5B, service data 504 may be received by an optimization module 510. Based on the service data, an optimization module 510 may generate a plurality of estimates 512. Each estimate 512 may correspond to an employee volume in the plurality of employee volumes 508. Further, each estimate 512 may indicate an average wait time for each of the tasks.

An example estimate 522 is shown in FIG. 5C Estimate 522 corresponds to an employee volume (“employee_volume_1”). As shown, estimate 522 may reflect service data 504, including the customer volumes for each task (“teller_volume,” “relationship_volume”) and the customer volume variations for each task (shown as a graph). Based on service data 504 and the corresponding employee volume (“employee_volume_1”), average wait times 524 (“average_wait_teller,” “average_wait_relationship”) may be determined and included in the estimate 522.

Another example estimate 526 is shown in FIG. 5C. Estimate 526 corresponds to another employee volume (“employee_volume_2”). As shown, estimate 526 may similarly reflect service data 504, including the customer volumes for each task (“teller_volume,” “relationship_volume”) and the customer volume variations for each task (shown as a graph). Based on service data 504 and the corresponding employee volume (“employee_volume_2”), average wait times (“average_wait_teller,” “average_wait_relationship”) may be determined and included in estimate 526.

Returning to FIG. 5B, optimization module 510 may be configured to select a subset of estimates 514 from the plurality of estimates 512 based on average wait times 524 for the teller tasks and the banking relationship tasks. For example, optimization module 510 may select for the subset estimates having average wait times 524 for one or both of the teller tasks and the banking relationship tasks that is less than and/or within a predetermined range of a target wait time. The subset of estimates 514 may be provided to a simulation module 516.

Simulation module 516 may further receive constraint data 506. Based on constraint data 506, simulation module 516 may generate simulations 518 for each estimate in the subset of estimates 514. An example simulation 530 is shown in FIG. 5D.

Simulation 530 may reflect constraint data 506. For example, simulation 530 may simulate the hours of operation, number of queues, maximum queue length, square footage, and employee attrition of bank branch 502 Simulation 530 may further reflect service data 504 included in the estimate. For example, simulation 530 may simulate the customer volumes, customer volume variation, and employee volume corresponding to the estimate. Simulation 530 may simulate average wait times for teller tasks and relationship banking tasks during the hours of operation of bank branch 502.

In some embodiments, an interface associated with simulation 530 may be provided to one or more output devices for display. In some embodiments, the interface(s) may graphically illustrate simulation 530. For example, the interface(s) may graphically illustrate bank branch 502. As another example, the interface(s) may graphically simulate customer volumes and/or average wait times. The interface(s) may take other forms as well.

Returning to FIG. 5B, optimization module 510 may receive simulations 518. Based on the simulations, optimization module 510 may generate an optimized decision 520. Optimized decision 520 may specify an optimized number of tellers, an optimized number of banking relationship employees, and an optimized number of universal branch assistants. The optimized numbers may be any number, including zero. In some embodiments, the optimized number of tellers, banking relationship employees,and/or universal branch assistants may specify both an optimized number of employees and identify individual employees (e.g., using employee identifiers) Alternatively or additionally, the optimized number of tellers, banking relationship employees, and/or universal branch assistants may simply specify an optimized number of employees, without identifying individual employees In some embodiments, the optimized decision may additionally specify an optimized work schedule for each teller, banking relationship employee, and universal branch assistant specified in the optimized decision.

In some embodiments, optimization module 510 may determine the optimized decision by comparing, for example, various numbers and work schedules of tellers, banking relationship employees, and universal branch assistants in connection with simulations 518 in order to determine an optimized number and/or optimized work schedule of tellers, banking relationship employees, and universal branch assistants. For example, optimization module 510 may consider whether and/or when a teller or a universal branch assistant should be scheduled to perform teller tasks. As another example, optimization module 510 may consider whether and/or when a banking relationship employee or a universal branch assistant should be scheduled to perform banking relationship tasks. Other examples as possible as well. Optimization module 510 may consider for example, relative cost of tellers, banking relationship employees, and/or universal branch assistants and/or relative efficiency of the tellers, banking relationship employees, and/or universal branch assistants. Other considerations are possible as well,

Optimization module 510 may be further configured to generate one or more interfaces associated with the optimized decision, such as an optimized decision 532 shown in FIG. 5E. In some embodiments, the interface(s) may graphically illustrate the optimized decision. For example, the interface(s) may graphically indicate the optimized number(s) of first, second, and/or third employees. As another example, the interface(s) may graphically illustrate an optimized work schedule for the optimized number(s) of first, second, and/or third employees. As shown, for instance, optimized decision 532 indicates an optimized number of and work schedule for two tellers, one banking relationship employee, and one universal branch assistant. The interface(s) may take other forms as well.

While the foregoing description focused on a single work location 502, a similar decision engine process may be implemented for multiple work locations. For example, in some embodiments, data 500 may include data for one or more additional work locations. In some embodiments, one or more first, second, and/or third employees may be indicated in both resource data 508 and resource data for one or more additional work locations, indicating that the employee(s) can work at either work location 502 or the one or more additional work locations. In generating estimates 512, estimation module 510 may generate estimates for both work location 502 and the one or more additional work locations. In some embodiments, where resource data indicates that an employee may work at work location 502 or one or more additional work locations, the estimation module 510 may generate estimates in which the employee works at both work location 502 and the one or more additional work locations. By providing these estimates to simulation module 514 and, potentially, optimization module 518, optimized decision 520 may reflect the possibilities of scheduling the employee to work at either work location 502 or the one or more additional work locations in generating optimized decision 520.

In some examples, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments. For example, while a financial service provider and merchant have been referred to herein for ease of discussion, it is to be understood that consistent with disclosed embodiments other entities may provide such services in conjunction with or separate from a financial service provider and merchant.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1-20. (canceled)

21. A system comprising:
a memory unit storing instructions;
a processor configured to execute the stored instructions to perform operations comprising:
receiving constraint data relating to a work location, wherein the constraint data comprises variations among work locations, variations in tasks requested by customers, or variations in employee skills:
receiving a plurality of estimates, wherein each estimate corresponds to an employee volume and an average wait time for a task at the work location;
generating simulations based on the constraint data and the estimates, wherein the simulations are generated according to customer inter-arrival distributions;
providing results of the simulations to an optimization module; and
generating an interface associated with the simulations.

22. The system of claim 21, wherein the results comprise an improved estimate of customer wait times for a task at the work location.

23. The system of claim 21, wherein the customer inter-arrival distributions are distributed according to an exponential distribution and the service time distribution are distributed according to a uniform distribution, a gamma distribution, a Weibull distribution, a normal distribution, a log-normal distribution, a beta distribution, or a triangular distribution,

24. The system of claim 21, wherein the interface associated with the simulations is configured for graphically illustrating the simulations.

25. The system of claim 24, wherein graphically illustrating the simulations comprises graphically illustrating the work location, customer volumes, or average wait times.

26. The system of claim 21, wherein at least one of the simulations comprises customer service at the work location.

27. The system of claim 21, wherein the constraint data comprise an hours of operation, a number of queues, a maximum queue length, a physical feature of the work location, or an employee attrition rate for the work location.

28. The system of claim 21, wherein the work location is a bank branch.

29. The system of claim 21, wherein each simulation comprises a customer time for a customer arriving at a certain time and seeking a certain task.

30. The system of claim 21, wherein each simulation reflects service data comprising a customer volume, a task, and a corresponding employee volume.

31. The system of claim 21, wherein the service data further comprises a number of employees trained for a task.

32. The system of claim 21, wherein each estimates is based on a customer arrival rate, an average customer service time at the work location for a task, and an estimation algorithm.

33. The system of claim 32, wherein the estimation ;algorithm involves an employee volume, a traffic intensity, and an employee occupancy.

34. The system of claim 21, wherein the plurality of estimates are a subset of estimates selected from among a larger plurality of estimates based on the average wait times indicated by the estimates.

35. The system of claim 21, wherein providing the results causes the optimization module to make an optimized decision based on the results and further causes the optimization module to display an interface associated with the optimized decision.

36. The system of claim 35, wherein the optimized decision specifies n optimized number of employees.

37. The system of claim 36 wherein the optimized decision further specifies an optimized work schedule for each employee in the optimized number of employees,

38. The system of claim 35, wherein the optimized decision is further based on costs of employees associated with the simulation results or efficiencies of employees associated with the simulation results.

39. A method, comprising:
receiving, by a processor, constraint data relating to a work location, wherein the constraint data comprise variations among work locations, variations in tasks requested by customers, or variations in employee skills;
receiving, by the processor, a plurality of estimates, wherein each estimate corresponds to an employee volume and an average wait time for a task at the work location;
generating, by the processor, simulations based on the constraint data and the estimates, wherein the simulations are generated according to customer inter-arrival distributions;
providing, by the processor, results of the simulations to n optimization module; and
generating, by the processor, an interface associated with the simulation.

40. A non-transitory computer-readable medium storing instructions that, when executed by one or more processors, cause the one or more processors to perform operations comprising:
receiving constraint data relating to a work location, wherein the constraint data comprise one of variations among work locations, variations in tasks requested by customers, or variations in employee skills;
receiving a plurality of estimates, wherein each estimate corresponds to an employee volume and an average wait time for a task at the work location;
generating simulations based on the constraint data and the estimates, wherein the simulations are generated according to customer inter-arrival distributions;
providing results of the simulations to an optimization module; and
generating an interface associated with the simulation.
